(19) United States
(12) Patent Application Publication
(10) Pub. No.: US 2009/0279515 A1
(43) Pub. Date: Nov. 12, 2009

(54) Apparatus and a method for service continuity between umts network and wlan

(76) Inventors: Kyung-Yul Cheon, Daejeon (KR); Kwang-Hyun Ro, Daejeon (KR); Jae-Wook Shin, Daejeon (KR); Hye-Yeon Kwon, Daejeon (KR); Kwang-Ryul Jung, Daeieon (KR); You-Sun Hwang, Daejeon (KR); Ae-Soon Park, Daejeon (KR)

Correspondence Address: STAAS & HALSEY LLP, SUITE 700, 1201 NEW YORK AVENUE, N.W., WASHINGTON, DC, 20005, US

(21) Appl. No.: 11/991,007

(22) PCT Filed: Aug. 24, 2006
(86) PCT No.: PCT/KR2006/003350

§ 371 Date: Feb. 26, 2008

(30) Foreign Application Priority Data
Aug. 26, 2005 (KR) 10-2005-0078878
Aug. 23, 2006 (KR) 10-2006-0080076

(51) Int. Cl. H04W 40/00; H04L 12/66; H04L 12/28

(52) U.S. Cl. 370/338; 370/352; 370/401

(57) ABSTRACT

The present invention relates to a method for guaranteeing service continuity between a 3GPP network and a non-3GPP network. According to the exemplary embodiment of the present invention, when a mobile station receiving a service from the 3GPP network moves to the non-3GPP network or it moves back to the 3GPP network from the non-3GPP network, an inter-working gateway inter-works with a SGSN or a GGSN through the 3GPP network to provide a seamless service to a mobile subscriber.

### TECHNICAL FIELD

The present invention relates to an apparatus for providing service continuity between a universal mobile telecommunication system network and a wireless local area network, and a method thereof. More particularly, the present invention relates to an apparatus for performing handover without a service drop between a 3rd Generation Partnership Project (3GPP) network and a non-3GPP network, and a method thereof.

### BACKGROUND ART

A universal mobile telecommunication system (UMTS) includes a third generation mobile communication system developed in a framework known as the International Mobile Communication (IMT)-2000 standard.

The third generation mobile communication system is designed for multimedia communication, and information access and service of pubic and private networks may be increased due to its high data speed and flexible communication may be performed. In addition, standards for the third generation mobile communication system have been discussed in the 3rd Generation Partnership Project (3GPP). Hereinafter, a system or a network suggested by the 3GPP will be referred to as a “3GPP system” or a “3GPP network”. In addition, a system or a network that is not suggested by the 3GPP will be referred to as a “non-3GPP system” or a “non-3GPP network” (e.g., a wireless local area network (WLAN)).

In the UMTS, there is a drawback in great spectrum consumption and low data rate, compared to the wireless local area network (WLAN). Accordingly, to complement bandwidth of the UMTS and increase efficiency, a system for using WLAN bands and a method thereof are required.

In a conventional Release 6-based 3GPP UMTS, a configuration for performing a roaming function for the 3GPP UMTS network and the WLAN of the non-3GPP network has been presented. That is, a configuration for receiving authentication and authorization services to the 3GPP network, accounting services, and a 3GPP network service when a 3GPP subscriber accesses the WLAN, and a method thereof, have been disclosed. Accordingly, when a mobile station accesses the WLAN, it may receive a packet service through the 3GPP network.

However, in a conventional configuration, when a mobile station accessing the 3GPP network moves to the WLAN when receiving a service from the 3GPP network, or vice versa, an address used by the mobile terminal in the previous network may not be used in the current network. That is, since it is required to provide a new address from a Gateway GPRS Support Node (GGSN) or a Packet Data Gateway (PDG) in the current network when the mobile station moves between the networks, the mobile station may not receive a seamless service.

The above information disclosed in this Background section is only for enhancement of understanding of the background of the invention and therefore it may contain information that does not form the prior art that is already known in this country to a person of ordinary skill in the art.

### DISCLOSURE

### Technical Problem

The present invention has been made in an effort to provide an apparatus for providing a seamless service between a 3rd Generation Partnership Project (3GPP) universal mobile telecommunication system (UMTS) network and a non-3GPP network, and a method thereof.

### Technical Solution

An exemplary apparatus for guaranteeing service continuity between a universal mobile telecommunication system network and a wireless local area network according to an embodiment of the present invention includes a first node, a second node, and an inter-working gateway. The first node transmits a data packet to a mobile station in a service coverage area in the universal mobile telecommunication system network. The second node performs a wireless gate function between the first node and a packet data network, and allocates a first address to the mobile station through the first node to perform data communication with the packet data network. The inter-working gateway receives the first address allocated from the second node through a first interface, and provides a seamless service to the mobile station by using the received first address, when the mobile station moves from the universal mobile telecommunication system network to the wireless local area network.

In this case, the inter-working gateway may form a tunnel to the mobile station by using the first address.

In addition, the inter-working gateway transmits the first address to the first node through the first interface to provide the seamless service when the mobile station moves back to the universal mobile telecommunication system network from the wireless local area network.

In an exemplary method for guaranteeing service continuity between a universal mobile telecommunication system network and a wireless local area network according to an embodiment of the present invention, a) a first address for performing data communication with a packet data network is allocated to a mobile station accessed to the universal mobile telecommunication system network, by a first node for performing a wireless gate function with a packet data network, b) a tunnel establishment request message is received from the mobile station moved to the wireless local area network from the universal mobile telecommunication system network, c) the allocated first address is received from the first node through a first interface, and d) a tunnel establishment response message having the received first address is transmitted to the mobile station.

In an exemplary method for guaranteeing service continuity between a universal mobile telecommunication system network and a wireless local area network according to another embodiment of the present invention, a) a packet data protocol (PDP) context activation request message is received from a mobile station moved back to the universal mobile telecommunication system network from the wireless local area network, by a first node for performing packet transmission, b) a PDP context generation request message is transmitted to the inter-working gateway by the first node by using a first interface, c) a PDP context generation response message having a PDP address is transmitted to the first node by the inter-working gateway (a second node for performing a wireless gate function with a packet data network allocates the PDP address to the mobile station accessed to the universal mobile telecommunication system network to perform data communication with the packet data network), and d) a PDP context activation response message is transmitted to the mobile station by the first node by using the received PDP address.

An exemplary inter-working gateway according to an embodiment of the present invention guarantees service continuity between a 3rd Generation Partnership Project (3GPP) network, having a serving general packet radio service (GPRS) support node (SGSN) and a gateway GPRS support node (GGSN), and a non-3GPP network. When a mobile station in the 3GPP network moves to the non-3GPP network, the mobile station receives a packet data protocol (PDP) address previously allocated from the GGSN through a Gn′ interface or a Gp′ interface, and forms a tunnel to the mobile station by using the received PDP address.

In this case, when the mobile station moves back to the 3GPP network from the non-3GPP network, the inter-working gateway transmits the PDP address to the SGSN through the Gn′ interface or the Gp′ interface so as to provide a seamless service.

### ADVANTAGEOUS EFFECTS

As described above, according to the exemplary embodiment of the present invention, a mobile station may receive a seamless service when moving between the 3GPP network and the non-3GPP network.

### DESCRIPTION OF DRAWINGS

FIG. 1 shows a diagram of a system for providing a seamless service between a 3GPP network and a non-3GPP network according to an exemplary embodiment of the present invention.

FIG. 2 shows a flowchart representing a mobile station when the mobile station in the 3GPP network moves to the non-3GPP network.

FIG. 3 shows a flowchart representing the mobile station when the mobile station moves back to the 3GPP UMTS network from the non-3GPP network.

### BEST MODE

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification. In addition, unless explicitly described to the contrary, the word “comprise” or variations such as “comprises” or “comprising” will be understood to imply the inclusion of stated elements but not the exclusion of any other elements.

In addition, the constituent elements, functions, and processes in the exemplary embodiment of the present invention may be realized as a combination of hardware and software, and they may be realized by at least one programmed universal device including a processor, a memory, and input/output interfaces.

An apparatus for guaranteeing service continuity between a 3rd Generation Partnership Project (3GPP) network and a non-3GPP network according to an exemplary embodiment of the present invention, and a method thereof, will now be described with reference to the figures.

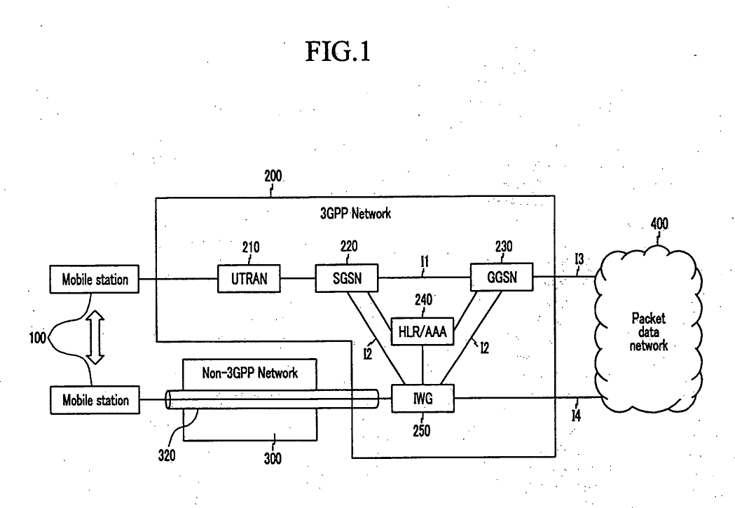

FIG. 1 shows a diagram of a system for providing a seamless service between a 3GPP network and a non-3GPP network according to the exemplary embodiment of the present invention. The system shown in FIG. 1 is exemplified to adopt a method and a system according to the exemplary embodiment of the present invention, and detailed descriptions of elements known to those skilled in the art will be omitted.

In FIG. 1, a mobile station 100 indicates a mobile terminal having dual modes of 3GPP and non-3GPP. A 3GPP network 200 indicates a mobile telecommunication system (UMTS), and a non-3GPP network 300 indicates wireless local area networks (WLANs) except for the 3GPP network. For example, the non-3GPP network 300 includes the IEEE 602.16, the hyper LAN, the wireless broadband (WiBro), and the personal area network (PAN).

As shown in FIG. 1, the 3GPP network 200 includes a UMTS terrestrial radio access network (UTRAN) 210, a serving general packet radio service (GPRS) support node (SGSN) 220, a gateway GPRS support node (GGSN) 230, a home location register (HLR)/authentication authorization accounting (AAA) unit 240, and an inter-working gateway (IWG) 250.

The UTRAN 210, which is a wireless access network, performs wireless functions, and it includes a node B (not shown) and a radio network controller (RNC) (not shown).

The SGSN 220 transmits a data packet to a mobile station 100 in a service coverage area, and performs a packet routing and transmitting function, a mobility management function, and a logical link management function. In addition, a location register of the SGSN 220 stores location information (e.g., a cell, and a visitor location register), and a profile of a user registered in the SGSN 220.

The GGSN 230 performs a wireless gateway function between the SGSN 220 and a packet data network (PDN) 400. That is, data are transmitted/received to/from the PDN 400 through the GGSN 230. In this case, the GGSN 230 allocates a packet data protocol (PDP) access to the mobile station 100 through the SGSN 220 so as to perform data communication with the PDN 400.

In FIG. 1, the SGSN 220 and the GGSN 230 are interlocked through a Gn/Gp interface 11. In this case, Gn is an interface in the same network, and Gp is an interface in different networks, and the Gp additionally includes a security function.

The HLR/AAA 240 stores a home location of the mobile station 100, and performs authentication for the mobile station.

The IWG 250 performs an inter-working operation so that a seamless service may be provided between the 3GPP network and the non-3GPP network, and it includes functions of the SGSN and the GGSN. In addition, the IWG 250 interfaces the SGSN 220 and the GGSN 230 through a Gn′/Gp′ interface 12. In this case, the Gn′/Gp′ interface 12, which has been suggested by 3GPP TS23.234, is a subset of the Gn/Gp interface and it includes a PDP context generation/deletion function and a GPRS tunneling protocol (GTP) tunnel generation function among Gn/Gp interface functions. Here, Gn′ is an interface in the same network, and Gp′ is an interface in different networks.

According to the exemplary embodiment of the present invention, when the mobile station 100 moves from the 3GPP network to the non-3GPP network, the IWG 250 receives the allocated PDP address from the GGSN 230 through the Gn′/Gp′ interface 12, provides the received PDP address to the mobile station 100, and forms a tunnel 320 with the mobile station 100. When the mobile station 100 moves back to the 3GPP network from the non-3GPP network, the IWG 250 transmits the PDP address provided to the mobile station 100 to the SGSN 220 through the Gn′/Gp′ interface 12 so as to provide the seamless service.

In FIG. 1, the PDN 400 indicates a packet-based network including the Internet and an intranet, and the GGSN 230 and the IWG 250 according to the exemplary embodiment of the present invention respectively include interfaces 13 and 14 so that the GGSN 230 and the IWG 250 respectively inter-work with the PDN 400.

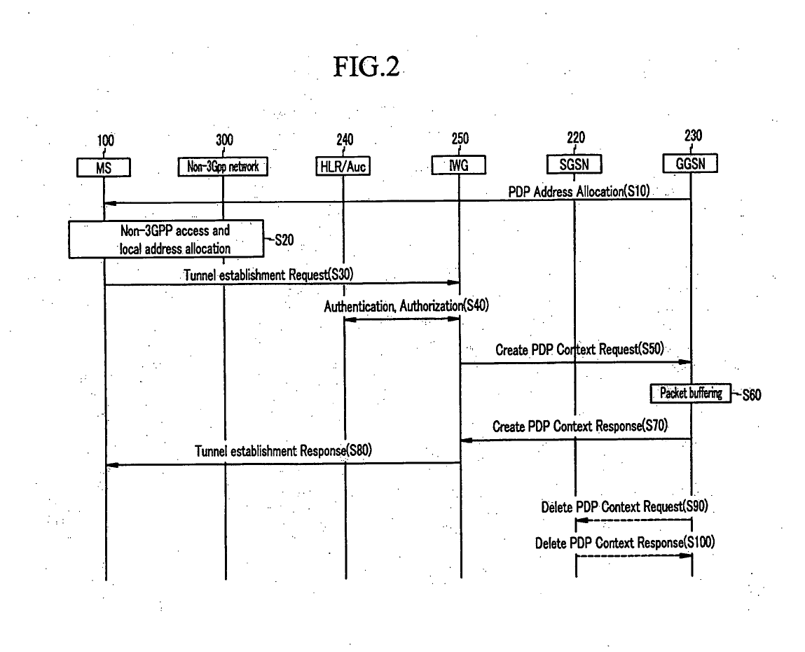

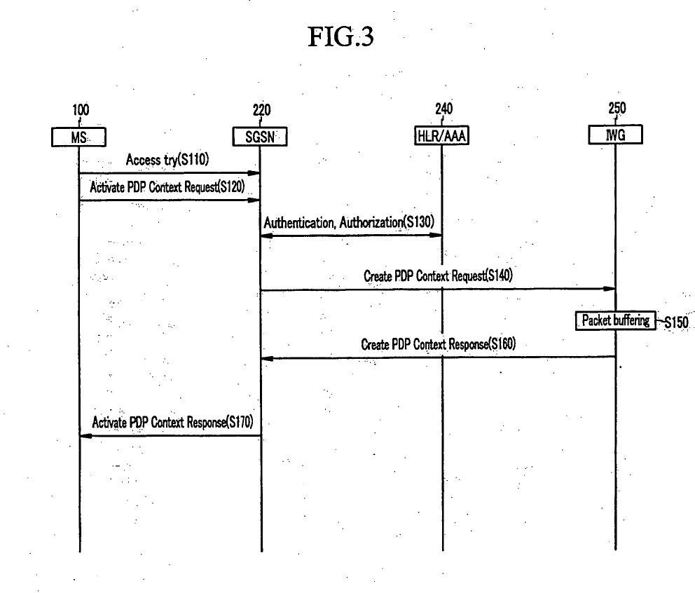

A service inter-working method between the 3GPP network and the non-3GPP according to the exemplary embodiment of the present invention will now be described with reference to FIG. 2 and FIG. 3.

FIG. 2 shows a flowchart representing movement of the mobile station from the 3GPP network to the non-3GPP network.

Firstly, when the mobile station 100 of a 3GPP subscriber accesses the 3GPP network 200, the mobile station 100 receives the PDP address from the GGSN 230 in step S10.

When the mobile station 100 moves to the non-3GPP network 300, the mobile station 100 receives a local address from the non-3GPP network 300 to perform the data communication in the non-3GPP network 300 in step S20.

Then, the mobile station 100 transmits a tunnel establishment request message to the IWG 250 in step S30. When the IWG 250 receives the tunnel establishment request message from the mobile station 100, the IWG 250 transmits a PDP context generation request message to the GGSN 230 by using the Gn′/Gp′ interface 12 after the HLR/AAA 240 performs a user authentication and authorization process, in step S50.

When receiving the PDP context generation request message, the GGSN 230 buffers packets toward the mobile station 100 requesting a tunnel in step S60, and transmits a PDP context generation response message to the IWG 250 by using the Gn′/Gp′ interface 12 in step S70. The PDP context response message according to the exemplary embodiment of the present invention includes the PDP address allocated in step S10. When the tunnel is completely generated, the buffered packet is transmitted to the mobile station 100 through the IWG 250.

Since the IWG 250 transmits a tunnel establishment response message including the PDP address obtained from the GGSN 230 to the mobile station 100, the tunnel 320 to the mobile station is generated.

By using the generated tunnel 320, the mobile station 100 may receive the seamless service for packet data transmitted to the 3GPP network, through the GGSN 230 and the IWG 250.

The GGSN 230 may cancel an existing general radio packet service (GRPS) session by using a PDP context deletion request message, and collect radio resources. That is, the GGSN 230 transmits the PDP context deletion request message in step S90 to cancel the GRPS session, and the SGSN 220 transmits a PDP context cancellation response message to the GGSN 230 to cancel the existing GRPS session and collect the radio resources in step S100.

When the PDP context deletion request message is not used, the SGSN 220 may cancel a session by using a mobile reachable timer.

FIG. 3 shows a flowchart representing the mobile station moving back to the 3GPP UMTS network from the non-3GPP network.

As described above in FIG. 2, when the mobile station 100 of the 3GPP subscriber accesses the non-3GPP network 300, the mobile station 100 receives the local address from the non-3GPP network 300, and receives the allocated PDP address from the IWG 250.

In this case, when the mobile station 100 moves back to the 3GPP network, the mobile station 100 tries to access the SGSN 220, and it transmits a PDP context activation request message to the SGSN 220 in step S120. The SGSN 220 inter-works with the HLR/AAA 240 to perform user authentication in step S130.

After performing the user authentication, the SGSN 220 uses the Gn′/Gp′ interface 12 to transmit the PDP context generation request message to the IWG 250 in step S140. When receiving the PDP context generation request message, the IWG 250 buffers the packet toward the mobile station 100 in step S150, and uses the Gn′/Gp′ interface 12 to transmit the PDP context response message to the SGSN 220 in step S160. According to the exemplary embodiment of the present invention, the PDP context response message includes the PDP address previously provided by the IWG 250.

Then, the SGSN 220 transmits a PDP context activation response message including the PDP address received from the IWG 250 to the mobile station 100.

Accordingly, the mobile station 100 may receive the seamless service when moving from the non-3GPP network 300 to the 3GPP network.

As described above, according to the exemplary embodiment of the present invention, when a mobile station moves from the 3GPP network to a non-3GPP network, or when it moves back to the 3GPP network from the non-3GPP network, the IWG 250 inter-works with the SGSN 220 or the GGSN 230 of the 3GPP network so that the mobile station may receive a seamless service without any service drop.

The above-described methods and apparatuses are not only realized by the exemplary embodiment of the present invention, but, on the contrary, are intended to be realized by a program for realizing functions corresponding to the configuration of the exemplary embodiment of the present invention or a recording medium for recording the program.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. An apparatus for guaranteeing service continuity between a universal mobile telecommunication system network and a wireless local area network, the apparatus comprising:
a first node for transmitting a data packet to a mobile station in a service coverage area in the universal mobile telecommunication system network;
a second node for performing a wireless gate function between the first node and a packet data network, and allocating a first address to the mobile station through the first node to perform data communication with the packet data network; and
an inter-working gateway for receiving the first address allocated from the second node through a first interface and providing a seamless service to the mobile station by using the received first address when the mobile station moves from the universal mobile telecommunication system network to the wireless local area network.

2. The apparatus of claim 1, wherein the inter-working gateway forms a tunnel to the mobile station by using the first address.

3. The apparatus of claim 1, wherein the inter-working gateway transmits the first address to the first node through the first interface to provide the seamless service when the mobile station moves back to the universal mobile telecommunication system network from the wireless local area network.

4. The apparatus of claim 1, wherein the first node is a serving general packet radio service (GPRS) support node (SGSN), and the second node is a gateway GPRS support node (GGSN).

5. The apparatus of claim 1, wherein the first address is a packet data protocol (PDP) address.

6. The apparatus of claim 5, wherein the first interface is a Gn′ interface or a Gp′ interface.

7. The apparatus of claim 5, wherein the inter-working gateway comprises a second interface for inter-working with the packet data network.

8. A method for guaranteeing service continuity between a universal mobile telecommunication system network and a wireless local area network, the method comprising:
allocating a first address to a mobile station by a first node for performing a wireless gate function with a packet data network, the first address for performing data communication with a packet data network, and the mobile station accessed to the universal mobile telecommunication system network;
receiving a tunnel establishment request message from the mobile station moved to the wireless local area network from the universal mobile telecommunication system network;
receiving the allocated first address from the first node through a first interface; and
transmitting a tunnel establishment response message having the received first address to the mobile station.

9. The method of claim 8, wherein receiving the allocated first address from the first node through a first interface comprises:
transmitting a packet data protocol (PDP) context request message to the first node by an inter-working gateway by using the first interface;
buffering a packet toward the mobile station by the first node; and
receiving a PDP context response message having the first address by the inter-working gateway from the first node through the first interface.

10. The method of claim 9, wherein receiving the allocated first address from the first node through a first interface further comprises
when receiving the tunnel establishment request message from the mobile station, inter-working with an authentication server and performing user authentication and authorization by the inter-working gateway.

11. The method of claim 8, further comprising:
transmitting a PDP context deletion request message to the second node by the first node (the second node transmits a data packet to the mobiles station in a service coverage area of the universal mobile telecommunication system network); and
transmitting a PDP context deletion response message to the first node, and canceling a session by the second node

12. The method of claim 8, wherein the first node is a gateway general packet radio service (GPRS) support node (GGSN).

13. The method of claim 12, wherein the first address is a PDP address.

14. The method of claim 12, wherein the first interface is a Gn′ interface or a Gp′ interface.

15. A method for guaranteeing service continuity between a universal mobile telecommunication system network and a wireless local area network, the method comprising:
receiving a packet data protocol (PDP) context activation request message from a mobile station moved back to the universal mobile telecommunication system network from the wireless local area network by a first node for performing packet transmission;
transmitting a PDP context generation request message to the inter-working gateway by the first node by using a first interface;
transmitting a PDP context generation response message having a PDP address to the first node by the inter-working gateway (a second node for performing a wireless gate function with a packet data network allocates the PDP address to the mobile station connected to the universal mobile telecommunication system network to perform data communication with the packet data network); and
transmitting a PDP context activation response message to the mobile station by the first node by using the received PDP address.

16. The method of claim 15, wherein the first node is a serving general packet radio service (GPRS) support node (SGSN), and the second node is a gateway GPRS support node (GGSN).

17. The method of claim 15, wherein the first interface is a Gn′ interface or a Gp′ interface.

18. An inter-working gateway for guaranteeing service continuity between a 3rd Generation Partnership Project (3GPP) network having a serving general packet radio service (GPRS) support node (SGSN) and a gateway GPRS support node (GGSN), and a non-3GPP network, wherein, when a mobile station in the 3GPP network moves to the non-3GPP network, the mobile station receives a packet data protocol (PDP) address previously allocated from the GGSN through a Gn′ interface or a Gp′ interface, and forms a tunnel to the mobile station by using the received PDP address.

19. The inter-working gateway of claim 18, wherein, when the mobile station moves back to the 3GPP network from the non-3GPP network, the inter-working gateway transmits the PDP address to the SGSN through the Gn′ interface or the Gp′ interface so as to provide a seamless service.

20. The method of claim 16, wherein the first interface is a Gn′ interface or a Gp′ interface.
